(19) United States
(12) Patent Application Publication
(10) Pub. No.: US 2023/0009816 A1
(43) Pub. Date: Jan. 12, 2023

(54) DERIVING INDUSTRY SECTOR SERVICE PROVIDER REPUTATION METRICS

(71) Applicant: International Business Machines Corporation, Armonk, NY (US)

(72) Inventors: Partho Ghosh, Kolkata (IN); Preetha Ghosh, Kolkata (IN); Venkata Vara Prasad Karri, Visakhapatnam (IN); Akash U. Dhoot, Pune (IN); Rajeev Kasarabada, Visakhapatnam (IN)

(21) Appl. No.: 17/372,638

(22) Filed: Jul. 12, 2021

(51) Int. Cl. G06Q 30/02; G06F 16/2457; G06N 20/00

(52) U.S. Cl. CPC G06Q 30/0282; G06F 16/24578; G06N 20/00

(57) ABSTRACT

Determines industry sector service provider metrics in order to generate insights and action plans for organizations. These generated insights recognize the gaps, pitfalls, and outliers in an organization's process lifecycle (such as an organization's hiring and onboarding process lifecycle) through the use of deep learning and artificial intelligence techniques.

### BACKGROUND

The present disclosure relates generally to the field of industry sector service providers, and more specifically to the reputation metrics the industry sector service providers utilize in order to determine whether organizational decisions that are made are optimal.

In this document, the terms “reputation metrics” and “reputation systems” are used interchangeably. The Wikipedia entry for “Reputation system” (as of Jun. 6, 2021) states as follows: “Reputation systems are programs or algorithms that allow users to rate each other in online communities in order to build trust through reputation. Some common uses of these systems can be found on E-commerce websites . . . as well as online advice communities . . . . With the popularity of online communities for . . . exchange of other important information, reputation systems are becoming vitally important to the online experience. The idea of reputation systems is that even if the consumer can't physically try a product or service, or see the person providing information, that they can be confident in the outcome of the exchange through trust built by recommender systems . . . . The role of reputation systems . . . is to gather a collective opinion in order to build trust between users of an online community.”

### SUMMARY

According to an aspect of the present invention, there is a method, computer program product and/or system that performs the following operations (not necessarily in the following order): (i) receiving an industry sector service provider data set, with the industry sector service provider data set including information indicative of a first process lifecycle; (ii) receiving a user feedback data set, with the user feedback data set including information indicative of a plurality of industry-based reputation metric score values provided by a first set of users; (iii) processing, using deep learning modules, the plurality of industry-based reputation metric score values to determine an industry reputation score; and (iv) responsive to the determination of the industry reputation score, using the industry reputation score to improve aspects of the first process lifecycle.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system; and

FIG. 4 is a flow diagram showing information that is helpful in understanding embodiments of the present invention.

### DETAILED DESCRIPTION

Some embodiments of the present invention are directed towards determining industry sector service provider metrics in order to generate insights and action plans for organizations. These generated insights recognize the gaps, pitfalls, and outliers in an organization's process lifecycle (such as an organization's hiring and onboarding process lifecycle) through the use of deep learning and artificial intelligence techniques.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

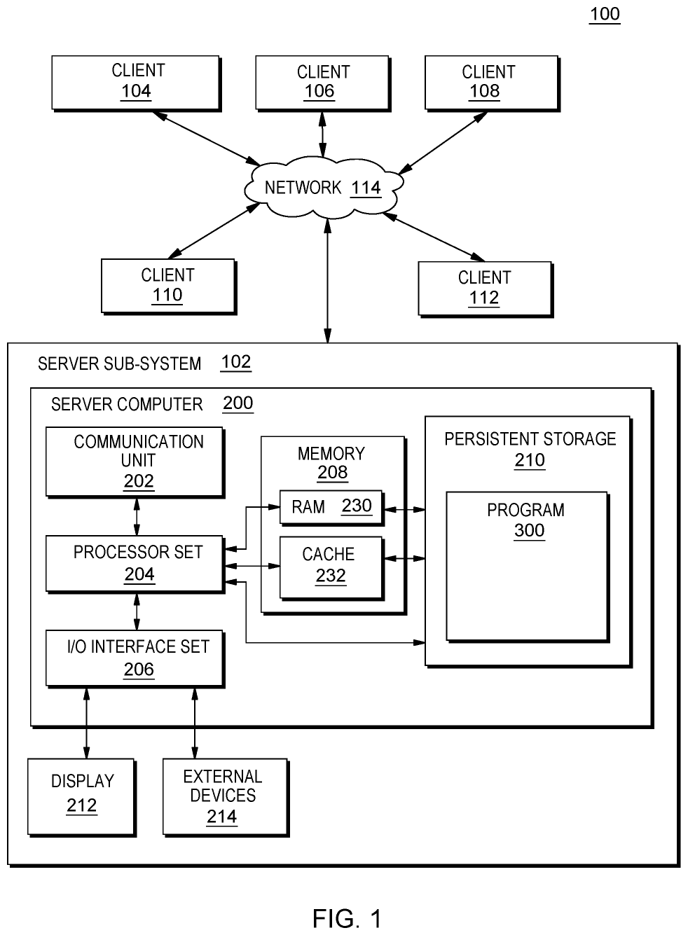

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

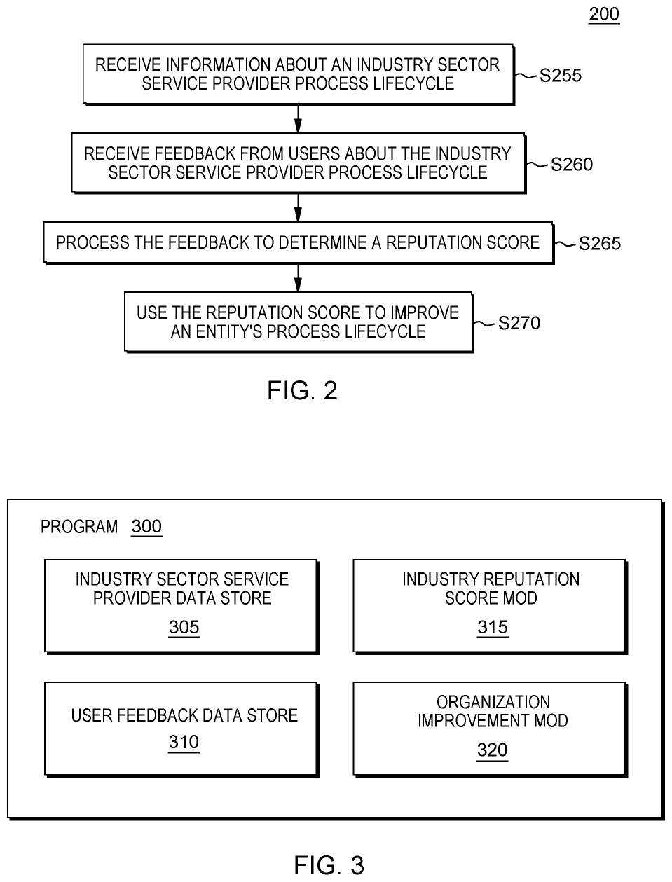

FIG. 2 shows flowchart 200 depicting a method according to the present invention. FIG. 3 shows program 300 for performing at least some of the method operations of flowchart 200. This method and associated software will now be discussed, over the course of the following paragraphs, with extensive reference to FIG. 2 (for the method operation blocks) and FIG. 3 (for the software blocks).

Processing begins at operation S255, where information about an industry service sector provider process lifecycle is received from industry sector service provider data store 305.

Processing proceeds to operation S260, where feedback from users about the industry service provider process lifecycle is received from user feedback data store 310.

Processing proceeds to operation S265, where industry reputation score module (“mod”) 315 processes the user feedback that is received (as discussed above in connection with operation S260) to determine an industry reputation score.

Processing finally proceeds to operation S270, where organization improvement mod 320 uses the industry reputation score (as determined above in connection with operation S265) to improve an organization's process lifecycle (such as an organization's hiring and onboarding process lifecycle).

### III. Further Comments and/or Embodiments

In this document, the term “reputation” as it pertains to an organization refers to the end user's overall impression or experience about an entity or a group of entities in a service oriented part of an organization. Tools, interactions, mediums of interactions, methodologies, products, processes (both physical and non-physical) are digitized and are using digital twin data by industry sector based for their day-to-day connections.

Examples of functional areas where various end user interact with respective industry service providers in various ways and generate an opinion based on his/her connection matrix and their experiences include: (i) shopping processes in e-commerce; (ii) logistics in e-commerce; (iii) mobility providers (such as ride sharing platforms); (iv) recruitment in Human Resources (HR); and (v) employee engagement in HR.

Some embodiments of the present invention identify everything about the Industry sector service providers process lifecycle experience, and not simply module driven experiences, including the minor drill down details of every interaction between the processing body through variety of mediums. This includes voice based telephonic interactions, to automated bot generated dialogues, web or mobile app metrics, and insights and action plans generated from it.

Embodiments of the present invention helps to determine gray areas, gaps, pitfalls, and outliers in an organizational industry sector service providers' process lifecycle (such as module driven experience, interactions and mediums of interactions between the involved service providers and the involved entities). The entities' experience feedback for any module or submodule or interactions or other involved entities can be used to strengthen any business process and reputation metrics can be improvised by providing insights and/or recommendations.

As used throughout this document, definitions for key recurring terms are presented below:

Industry Sector: specialized functional area (such as HR, Medical, Logistics.

Service Provider: any internal or external application or service or utility owned or used by or in the industry.

Entity: any component within the service offering provided by the service provider. For example, for recruitment purposes, this can include candidate experience, recruiter identity information, and candidate on-boarding information. For e-commerce purposes, this can include buyer and seller identity related information, supplier information, warehouse operational information, logistics, dealer identity related information and customer support information. For vehicle-aggregation and mobility purposes, this can include: agent and chauffer related information, passenger related information, location information, payment information and vehicle information.

User: any customer or candidate or end user who is interacting with the industry provided service and his or her interaction(s) with various entities in the service offering.

Types of Interactions: (i) user-system; (ii) system-system; and (iii) user-user.

Mediums of Interactions: (i) automated systems; (ii) web-based interactions; (iii) chatbots; (iv) in-person interactions; and (v) phone interactions.

Some embodiments of the present invention include cognitive techniques for deep learning and for deriving a 360-degree analysis of an industry sector service provider in an entity to determine end user connection attributes for “satisfaction reputation” of multiple entities. These embodiments use industry sector service providers for various interaction(s) using different mediums of interactions and thereby generate Key Performance Indicators (KPI) for each phase and each interaction against that medium of interaction.

Some embodiments of the present invention include blockchain-enabled governance and industry benchmarking/rating for overall Entity satisfaction experience. This is based on various attributes including changing dynamics of the technology landscape, change or delta in the domain related methodologies, types and techniques, change in psychological attributes, and experiences of the involved entities.

For example, if the interaction is between a recruiter and prospective employee, the technical manager and prospect employee is the overall context. Embodiments of the present invention will identify the context, interaction and perform a tone analysis to each of those interactions with the recruiter and also with technical manager and calculate the delta to determine the positive reputation or a negative reputation for all the interactions. This can traverse back in a blockchain network to pull the specific block that led to a potential negative interaction which can be used for multiple purposes.

Some embodiments of the present invention include capabilities for using an Interaction(s) Derivation Engine (IDE) that can collate and categorize both tangible and intangible covariates. This IDE has the capability of identifying events of interest describing a direct or intermediary interaction of users within the industry sector service and thereby determine a plurality of tangible and intangible covariates that have a causative reverberation on user satisfaction experience for the Industry Sector Service provider.

Embodiments of the present invention additionally have the following capabilities: (i) estimating a predicted value and an associated error-variance for the prominent covariates; and (ii) generate derived co-variates and their corresponding values by correlating the tangible and intangible covariates (discussed above) with a benchmarked corpus of various metric system that correspond to a particular industry sector service. These metrics include tracking metrics, Artificial Intelligence (AI) metrics, reliability metrics, performance metrics, tone and behavior metrics, churn or drop-off metrics, Internet of Things (IoT) metrics, statistical metrics, and financial metrics.

Prominent covariates corresponding to their respective Industry Sector are provided below:

For the recruitment industry sector, the covariates include: time to hire, time to fill a job, NPS scores, SEO rankings, career page, and social page feedbacks, offer acceptance rate for the employer, onboarding effectiveness score, onboarding timelines, employee First-year turnover, source-channel cost, candidate and recruiter satisfaction levels with hiring process and systems.

For the e-commerce industry sector, the covariates include: inventory accuracy, inventory turnover, inventory carrying cost, percentage loss/damage in storage or transportation, replenishment cycle time, customer communication, average transit time, and order completeness.

For the vehicle-aggregation and mobility industry sector, the covariates include: chauffeur rating, new user sign ups, driver turn over, gross bookings, driver referrals, rider incentives, and vehicle travel time. Novel covariates corresponding to their respective Industry Sector are provided below:

For the recruitment industry sector, the covariates include: relatable and effective job description score, job application scores (including both relevant scores and effective application scores), job description clarity, productivity preparedness timeline of a new hire's productivity and effectiveness score.

For the vehicle-aggregation and mobility industry sector, the covariates include: agent/chauffeur reliability score, chauffeur/vehicle SOS score, chauffeur intention by tone analysis, chauffeur driving pattern, unjustified vehicle re-routing, unjustified chauffeur fines or penalty, bad incentive scheme by provider, metric sharing transparency score(earnings of driver, profit margin, no of hours or overtime), driver burnout score, driver rest time for meals, supply redirection during peak hours, and variance in time or route between similar end points.

Some embodiments of the present invention include methods to derive an OEER (Overall Entity Experience Reputation) which would collate a given entities' experience reputation Scores of all involved entities and subsystems from a reputation scoring unit. In some embodiments, AI and Deep Learning techniques can be used on: (i) prominent covariates predicted values; (ii) derived covariates and their predicated values; and (iii) consequence factor of prominent and derived covariates from historical analysis of metrics data of an Industry Sector Service.

Embodiments of the present invention can auto generate insight on the reputation metrics by context for a given user and his or her interactions with respect to service effectiveness and likeliness of remaining in the system for that specific industry sector by region and by the service providers and by functional domain.

In some embodiments, applied analysis on shared entity experience in different domains in one centralized repository from various blockchain blocks are collated and securely identify the covariates and the associated interaction events that have a high subscription score that contribute to positive or negative entity experience. This applied analysis also suggests the same to introduce/optimize/remove in other domains for better engagement of all involved entities for that specific location that is also in-line with geographic laws and guidelines.

In some embodiments, the recurring feedback crawler is integrated with an emotional analysis engine that has the capability to auto-identify the negative tone of any user feedback about the organization/company/service provider for which he or she intended to take the service in an open source and/or social site. This allows for that feedback with the block present in the internal blockchain system to generate an insight report as to whether a valid comment by the user was provided. If not, notify the social sites' administrator to act on the feedback comment that was posted and/or not count that comment for overall score or rating of company in the market.

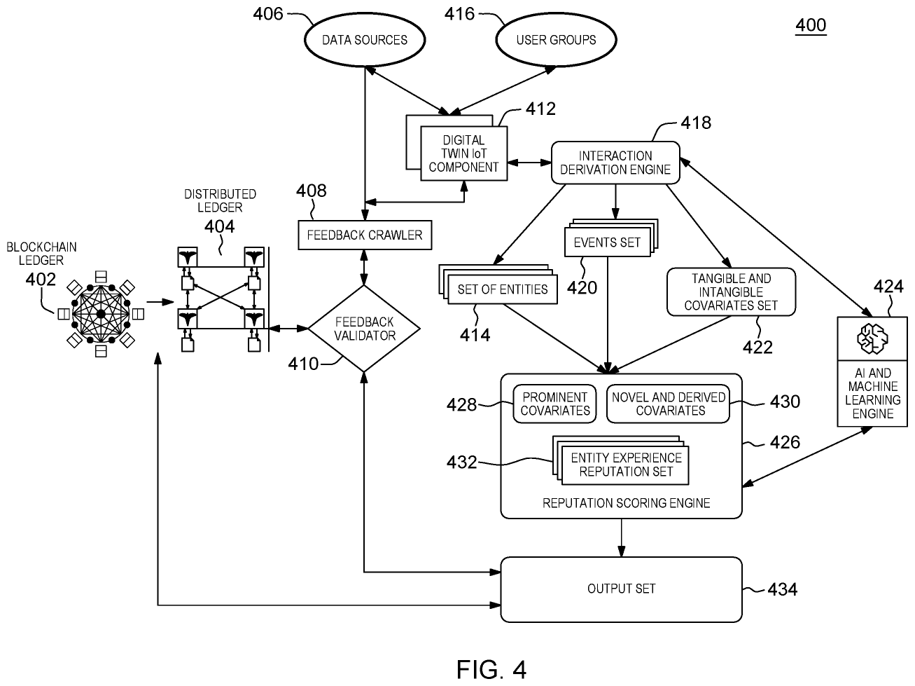

Flow diagram 400 of FIG. 4 shows a variety of components that are included in certain embodiments of the present invention (as further discussed in connection with real world use-cases, below).

Flow diagram 400 includes at least the following components: blockchain ledger 402, distributed ledger 404, data sources 406, feedback crawler 408, feedback validator 410, digital twin IoT component 412, set of entities 414, user groups 416, interaction derivation engine 418, events set 420, tangible and intangible covariates set 422, AI and machine learning engine 424, reputation scoring engine 426 (with engine 426 including prominent covariates 428, novel and derived covariates 430, and entity experience reputation set 432), and output set 434. Output set 434 includes information indicative of negative covariates for associated entities and associated interaction events, positive covariates for associated entities and associated interaction events, generated insights, and an industry sector service provider reputation score.

Various implementations for use-cases will now be discussed.

Shopping Process Lifecycle:

This can also be explained with the use case in the field of e-commerce, where an e-commerce user experience is the entire process (single process and combination of all integrated processes) when a buyer learns about a product, launches the website/app, adds the product to cart, does the payment, tracks the product and finally receives the product or leave the e-commerce site without purchasing.

In general term the online user is forming an opinion about the e-commerce service provider and how the service provider handles the customer queries.

If a user builds a great customer experience, customers typically provide positive word of mouth reviews.

Embodiments of the present invention determine grey areas in the entire e-commerce process. This includes starting from (1) navigating the website to find a product, (2) selecting the item, (3) adding to cart, (4) checking out the item, (5) making the payment, and (6) receiving the item everything until the user accepts the item or return the item and request for refund/exchange.

Additionally, embodiments of the present invention identifies the following areas of dissatisfaction in case of exchange or refund: (1) wait time of customer to speak to a customer care representative, (2) time spent by the customer in a call to get connected to appropriate representative as there involves numerous transfers to different departments, and (3) dissatisfaction of a customer measured if the representative, lacks the skills to reply the customer queries.

Industry metrics for prominent covariates include the following:

Average acquisition cost: measures how much it costs to acquire a new customer.

Customer lifetime value (CLV): measures how much any given customer spends with a given online shop throughout the customer lifecycle. It is calculated by subtracting the acquisition cost from the revenue earned.

Retention rate and share of repeating customers: the customers that are consistently returning. It is measured by calculating how many customers are acquired in a certain past period of time that came back after to purchase more goods/services.

Conversion rate: measures how many visitors convert into customers. One of the most common problems of e-commerce entrepreneurs is getting heavy traffic and few to no sales.

Average margin: the amount earned from each product after deducting what is paid for supplying it.

Additional metrics include: refund and return rate, support rate, website/APP traffic, email opt-in rate, shipping time, order accuracy, delivery time, transportation costs, warehousing costs, number of shipments, inventory accuracy, inventory turnover, inventory to sales ratio, number of clicks on products' cards, navigation flow, duration of a session, new traffic versus recurrent traffic, bounce percentage, industry metrics based on novel covariates, and cart abandonment rate.

Metrics further include: relatable and effective product description score, e-commerce page navigability score (determines the delta of navigability wherein the delta being minimal means buyers likelihood to navigate through the e-commerce page product listings with a minimum number of clicks), e-commerce page search clarity score, and effective product detail score.

Mobility Process Lifecycle:

Embodiments of this use-case utilize news articles and personal information (such as from interviews) with respect to indicators such as user safety, location intelligence (for example, whether or not a given ride-sharing vehicle has arrived at its requested location), two-factor authentication for both customers and drivers.

In this particular use-case, prominent covariates include the following: driver ratings, driver turnover, user ratings, user turnover, new rider sign-ups, rider incentives, number of riders and drivers in a location based on a predefined time period, supply redirection, call answer rate, passenger wait time for arrival of a ride-sharing vehicle, driver safety, engagement (both customer and company), complaint management, efficiency (consumed fuel cost divided by fuel consumed), and vehicle maintenance.

In this use-case, novel covariates include the following: driver satisfaction through tone and behavior analysis, IoT based determination of a safe distance between vehicles, driver attentive hours, IoT based tone analysis, and idling (IoT based engine idling violation metrics, and idling duration).

Recruitment Process Lifecycle:

Some embodiments of the present invention recognize the following: (i) from the moment candidates browse a given company's careers page to when he or she receives a job offer and are then are onboarded, the candidates are forming an opinion about the company and how the candidates are treated; (ii) during the entire lifecycle of the recruitment process, each system, subsystem, interaction does impact on the opinion of an organization's reputation; (iii) the candidate experience timeline begins from the moment a job seeker learns about an open position at the company and continues throughout the candidate's interview process; (iv) the recruitment process lifecycle ends with a job offer or rejection letter; (v) candidate experience surveys can be used to reveal strengths and weaknesses in each stage of the hiring process, so that companies can continue to refine and improve their recruiting strategy.

In this given use-case, industry metrics based prominent covariates include the following: career page feedback, interview feedback, candidate's job and organization-based expectations, NPS of career page/hiring products, SEO ranking of career pages, source channel of hire (such as social media, agency, referral, career development website, etc.), sourcing channel effectiveness (including number of successful hires from the channel/total number of applications received from the channel), sourcing channel cost, career page conversion rate from tracking analytics, current candidate satisfaction levels, hiring manager satisfaction levels, vacancy rate, application drop off rate, cost to fill, time to start, pipeline conversion rate, hiring velocity, career page conversion rate, recruitment email open rate, recruitment email response rate, recruitment email click-through rate, recruitment email conversion rates, time to hire, attributes and employer first year turnover rate, application abandonment rate, offer acceptance rate, and yield ratio in an interview stage.

Additional industry metrics based prominent covariates include the following: relatable and effective job description score, communication sentiment, communication intention, communication bias between the hiring team and candidate, effective job application score (determined by: length of the application, whether all the fields are necessary, whether unnecessary information being requested, whether redundant information being requested, does the format make sense, etc.), relevant job application score, conscious and unconscious bias at every stage of the interviewing and hiring process, and careers page reachability score.

Some embodiments of the present invention have the capability to identify events of interest that describe a direct or intermediary interaction of a given candidate with the hiring body. This allows for the plurality of tangible and intangible covariates that have a causative impact on candidate experience of a hiring body to be determined. Some embodiments of the present invention have the capability to estimate a predicted value for the prominent covariates and an associated error-variance from identified events of interest (discussed above).

In some embodiments, the prominent covariates include the following: (i) career page feedback; (ii) interview feedback; (iii) candidate's expectations from a given job and the organization; (iv) NPS of the career page/hiring products; (v) SEO ranking of career pages; (vi) source of hire (such as social media, agency, referral, etc.); (vii) career page conversion rate from tracking analytics; (viii) current candidate satisfaction levels; (ix) highs and lows of a given hiring process (typically from survey-related feedback from recruiters or a hiring body); (x) hiring velocity (that is, the average amount of time it takes to move a candidate from one hiring stage to another); and (xi) career page conversion rate.

In some embodiments, a career page's conversion rate is the percentage of the career page's visitors that applied to job openings from the given hiring body. In order to measure the career page conversion rate, it is necessary to divide the number of unique visitors on the career page within a specific time frame by the number of applications that are received within the same period.

Some embodiments of the present invention have the ability to derive unique covariates and estimate a predicted value and an associated error-variance from the identified events of interest.

In some embodiments, the unique covariates include the following: (i) relatable and effective job description score; (ii) communication sentiment, communication intention, and communication bias between the hiring body and the candidate. (for example, how clearly did the recruiter explain the hiring process and the job description, what was the tone of the recruiter while speaking to the candidate, and did the recruiter notify the candidate in good faith after determining that the candidate was not successful in the hiring process); and (iii) effective job application score.

The effective job application score takes into consideration factors such as: length of application, determining whether all of the application fields are necessary, determining whether relevant information is being sought, determining whether information being sought includes information from resumes and social profiles, determining whether the format is appropriate (multiple-choice versus open-ended questions), determining whether the recruiter reflects on what an applicant read in the job description.

Additional unique covariates include: (i) relevant job application score (based on whether the questions in a given job application is related to the job being applied for); (ii) conscious and unconscious bias at every stage of the interview/hiring stage; (iii) careers page reachability score (based on whether: the career page has a web/mobile app, voice app, etc. and/or the career page is integrated with different job boards); (iv) employer branding and career page user experience score; (v) job response conversion rate (calculated by the number of candidates who received an acceptance or rejection response divided by the number of candidates applied multiplied by 100); and (vi) career page navigability score (determines the delta of navigability wherein the delta is a minimal means candidates likelihood to navigate through the career page job listings with a minimum number of clicks).

Additional unique covariates further include: (i) time to fill a job application (Artificial Intelligence (AI) Bots can be used to replicate a candidate's persona and predicts the mean time required to fill a job application); (ii) number of Interviews per hire; (iii) apply to interview velocity (asks how much time was taken to move a candidate from the first stage of interview after a successful application submission); (iv) job benefit score (benefits are the company and team benefits mentioned in the job description); (v) number of qualified candidates per hire; (vi) notice period expectancy deviation (deviation of organization notice period versus job notice period); (vii) job content mapping accuracy from a manager to a recruiter (expectations of a manager for a potential new hire versus job content framed by a recruiter); and (viii) job description clarity score.

Some embodiments of the present invention have the capability to fetch and perform historical analysis on the candidate experience metrics data of an organization to predict a consequence factor against each of the covariates of adequate and inadequate candidate experience profiles in different stages and situations of the hiring process of a hiring body.

Some embodiments of the present invention derives a “candidate experience reputation” score from a reputation scoring unit. In this embodiment, AI and Deep Learning techniques are used on the covariates and their corresponding significance factors from previously described embodiments (discussed above).

In some embodiments of the present invention, there is a system that determines covariates and the associated interaction events between a given candidate and a hiring body that have a high subscription score. This high subscription score ultimately leads to a high candidate experience reputation score. From this score, insights can be generated, including the following: (i) possible changes; (ii) plans/scheme; (iii) improvements in the hiring process; (iv) improvements in the career page; (v) employer branding and advertisements; (vi) improvements for reachability of jobs; and (vii) empathy and behavioural training for recruiters.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
receiving an industry sector service provider data set, with the industry sector service provider data set including information indicative of a first process lifecycle;
receiving a user feedback data set, with the user feedback data set including information indicative of a plurality of industry-based reputation metric score values provided by a first set of users;
processing, using deep learning modules, the plurality of industry-based reputation metric score values to determine an industry reputation score; and
responsive to the determination of the industry reputation score, using the industry reputation score to improve aspects of the first process lifecycle.

2. The computer-implemented method of claim 1 wherein the industry reputation score includes information indicative of effective job description score.

3. The computer-implemented method of claim 1 wherein the industry reputation score includes information indicative of entity productivity preparedness.

4. The computer-implemented method of claim 1 wherein the industry reputation score includes information indicative of applicant productivity preparedness.

5. The computer-implemented method of claim 1 wherein the industry reputation score includes information indicative of an entity's search engine optimization (SEO) rankings.

6. The computer-implemented method of claim 1 wherein the industry reputation score includes information indicative of an entity's onboarding effectiveness score.

7. A computer program product (CPP) comprising:
a machine readable storage medium; and
computer code stored on the machine readable storage medium, with the computer code including instructions and data for causing a processor(s) set to perform operations including the following:
receiving an industry sector service provider data set, with the industry sector service provider data set including information indicative of a first process lifecycle,
receiving a user feedback data set, with the user feedback data set including information indicative of a plurality of industry-based reputation metric score values provided by a first set of users,
processing, using deep learning modules, the plurality of industry-based reputation metric score values to determine an industry reputation score, and
responsive to the determination of the industry reputation score, using the industry reputation score to improve aspects of the first process lifecycle.

8. The CPP of claim 7 wherein the industry reputation score includes information indicative of effective job description score.

9. The CPP of claim 7 wherein the industry reputation score includes information indicative of entity productivity preparedness.

10. The CPP of claim 7 wherein the industry reputation score includes information indicative of applicant productivity preparedness.

11. The CPP of claim 7 wherein the industry reputation score includes information indicative of an entity's search engine optimization (SEO) rankings.

12. The CPP of claim 7 wherein the industry reputation score includes information indicative of an entity's onboarding effectiveness score.

13. A computer system (CS) comprising:
a processor(s) set;
a machine readable storage medium; and
computer code stored on the machine readable storage medium, with the computer code including instructions and data for causing the processor(s) set to perform operations including the following:
receiving an industry sector service provider data set, with the industry sector service provider data set including information indicative of a first process lifecycle,
receiving a user feedback data set, with the user feedback data set including information indicative of a plurality of industry-based reputation metric score values provided by a first set of users,
processing, using deep learning modules, the plurality of industry-based reputation metric score values to determine an industry reputation score, and
responsive to the determination of the industry reputation score, using the industry reputation score to improve aspects of the first process lifecycle.

14. The CS of claim 13 wherein the industry reputation score includes information indicative of effective job description score.

15. The CS of claim 13 wherein the industry reputation score includes information indicative of entity productivity preparedness.

16. The CS of claim 13 wherein the industry reputation score includes information indicative of applicant productivity preparedness.

17. The CS of claim 13 wherein the industry reputation score includes information indicative of an entity's search engine optimization (SEO) rankings.

18. The CS of claim 13 wherein the industry reputation score includes information indicative of an entity's onboarding effectiveness score.
